(19) United States
(12) Patent Application Publication
(10) Pub. No.: US 2008/0314891 A1
(43) Pub. Date: Dec. 25, 2008

(54) Electric Stove

(75) Inventor: Masaaki Takita, Osaka (JP)

Correspondence Address: OKADA;C/O KEATING & BENNETT, LLP, 1800 Alexander Bell Drive, SUITE 200, Reston, VA, 20191, US

(73) Assignees: TAKITA RESEARCH & DEVELOPMENT CO., LTD., Ibaraki-shi, Osaka (JP); TSUJIMURA GIKEN CO., LTD., Yao-shi, Osaka (JP)

(21) Appl. No.: 11/572,052

(22) PCT Filed: Jul. 14, 2004
(86) PCT No.: PCT/JP2004/010048

§ 371 Date: Jul. 26, 2007

(51) Int. Cl. F27D 11/00; H05B 1/00

(52) U.S. Cl. 219/385; 219/219

(57) ABSTRACT

An object is to provide an electric stove which can increase the flexibility of design and further improve thermal efficiency.

An electric stove 10 includes electric heating elements 32a and 32b disposed out of positions immediately below objects to be heated 62, partially elliptical mirror sections 16a and 16b reflecting heat rays radiated from the electric heating elements 32a and 32b, and first reflective mirror sections 22a and 22b disposed below the electric heating elements 32a and 32b to gather the heat rays reflected by the partially elliptical mirror sections 16a and 16b towards the lower sides of the objects to be heated 62. The partially elliptical mirror sections 16a and 16b have one foci F1a and F1b in the vicinity of the electric heating elements 32a and 32b, respectively. The partially elliptical mirror sections 16a and 16b are connected to the first reflective mirror sections 22a and 22b, respectively, so that the major axes connecting the one foci F1a and F1b of the partially reflective mirror sections 22a and 22b to the other foci F2a and F2b, respectively, cross the first reflective mirror sections 22a and 22b appropriately at a desired angle Y.

### TECHNICAL FIELD

The present invention relates to an electric stove, and in particular, to an electric stove which heats an object to be heated by radiant heat to cook, for example, fish, meat, and other foodstuffs.

### BACKGROUND ART

As a prior art technology being the technical background of the present invention, there was an electric stove which could suppress the occurrence of smoke as much as possible and minimized the size thereof so as to be easily used for cooking in ordinary households. This type of electric stove, for example, includes two support plates, and two mirror sections are disposed oppositely to each other between the two support plates at a predetermined distance away. Each of the two mirror sections is composed of a first partially elliptical cylindrical surface and a second partially elliptical cylindrical surface. Inside the two mirror sections, electric heating elements such as seethe heaters are disposed out of positions directly below the object to be heated. One of the foci of the first partially elliptical cylindrical surface and one of the foci of the second partially elliptical cylindrical surface are aligned in the same axis, and the electric heating elements are disposed in the vicinities of the foci (for example, refer to Patent Document 1).

In the two mirror sections of this electric stove, heat rays radiated from the electric heating element disposed in the vicinity of the one focus of the first partially elliptical cylindrical surface are reflected by the first partially elliptical cylindrical surface and gathered to the other focus of the first partially elliptical cylindrical surface, and then applied to the object to be heated. Part of the heat rays, which is not applied to the object to be heated, is reflected by the second partially elliptical cylindrical surface of each mirror section and reflected by the first partially elliptical cylindrical surface of the opposed mirror section, and then is applied to the object to be heated. In other words, in this electric stove, the first partially elliptical cylindrical surfaces have the function of heating to heat the object to be heated, and the second partially elliptical cylindrical surfaces have the function of improving efficiency to efficiently apply the heat rays radiated from the electric heating element on the object to be heated.

Patent document 1: Japanese Patent Laid-Open Publication No. 2002-340345 (pages 3 to 4, FIGS. 1 to 3)

### DISCLOSURE OF THE INVENTION

### Problems to be Solved by the Invention

In such an electric stove, however, the mirror section is integrally formed by the first partially elliptical cylindrical surfaces and the second partially elliptical cylindrical surfaces. One of the foci of the first partially elliptical cylindrical surface and one of the foci of the second partially elliptical cylindrical surface are aligned in the same axis, and the electric heating elements are disposed in the vicinities of the foci. Since the mirror sections and the electric heating elements are disposed so as to increase thermal efficiency as much as possible, the flexibility of design such as widening or narrowing the distance between one mirror section and the other mirror section in accordance with the size of the object to be heated is necessarily little.

Also, in such an electric stove, when the diameter of the seethe heater is large or the like, the heat rays radiated from the electric heating element remain inside the mirror section according to the size of the electric heating element, so that there is a case where the heat rays, which are not applied on the object to be heated, cannot be efficiently reflected by the second partially elliptical cylindrical surface and applied on the first partially elliptical cylindrical surface of the opposed mirror section. In this case, since the heat rays cannot be controlled well, the efficiency of reflecting the heat rays from one mirror section by the other opposed mirror section deteriorates. In other words, the second partially elliptical cylindrical surface cannot sufficiently perform the function of improving its efficiency and losses occur, so that it is still difficult to sufficiently improve its thermal efficiency.

Furthermore, when fish, meat, and other foodstuffs are cooked by such an electric stove, contamination due to meat juice, oil, and the like adheres mainly to the mirror sections and the like. In particular, in the vicinity of one focus of the first partially elliptical cylindrical surface (in the vicinity of the electric heating element) and in the vicinity of the other focus of the first partially elliptical cylindrical surface, it is difficult to remove the contamination adhering to the mirror sections in the vicinity of the foci because the mirror sections become hot. To clean the contamination adhering to the mirror sections off, there are a case where a hand is inserted between the two mirror sections for cleaning and a case where the mirror sections and the electric heating elements are detached from the support plate and they are cleaned. In the former case, cleaning immediately after used brings the danger of a burn and the like because the vicinity of the electric heating element is hot, so that the contamination has to be cleaned off after a certain lapse of time. In the latter case, on the other hand, since the process of detaching the mirror sections and the electric heating elements from the support plate is necessary whenever they are cleaned, the cleaning becomes very troublesome.

Accordingly, a main object of the present invention is to provide an electric stove which has a high degree of flexibility in design. Another object of the present invention is to provide an electric stove which can further increase thermal efficiency. Still another object of the present invention is to provide an electric stove which can be easily cleaned.

### Means to Solve the Problems

The present invention according to claim 1 is an electric stove including: an electric heating element disposed out of a position immediately below an object to be heated; a mirror section for reflecting heat rays radiated from the electric heating element; and a first reflective mirror section disposed below the electric heating element to gather the heat rays reflected by the mirror section towards the lower side of the object to be heated. The mirror section includes a partially elliptical mirror section which has one focus in the vicinity of the electric heating element to reflect the heat rays radiated from the electric heating element. The partially elliptical mirror section is connected to the first reflective mirror section so that the major axis connecting the one focus of the partially elliptical mirror section to the other focus of the partially elliptical mirror section appropriately crosses the reflective mirror section at a desired angle.

The present invention according to claim 2 depends on the invention according to claim 1, wherein the electric stove further includes a second reflective mirror section. The second reflective mirror section is disposed below the object to be heated to gather heat rays, which are radiated from the electric heating element and are not reflected by the first reflective mirror section, towards the lower side of the object to be heated.

The present invention according to claim 3 depends on the invention according to claim 2, wherein the partially elliptical mirror section includes an upper section and a lower section which can be separated in two in a vertical direction. The electric heating element is supported by the upper section of the partially elliptical mirror section, and the lower section of the partially elliptical mirror section is integrally formed with the first reflective mirror section.

The present invention according to claim 4 depends on the invention according to any of claims 1 to 3, wherein the electric stove further includes an anti-degradation film formed at least on any surface of the mirror section and the first reflective mirror section on which the heat rays are applied.

The present invention according to claim 5 depends on the invention according to any of claims 1 to 4, wherein at least any surface of the lower section of the partially elliptical mirror section, the first reflective mirror section, and the second reflective mirror section, on which the heat rays are applied, has heat resistance, and a protection member which does not prevent the reflection of the heat rays is detachably attached thereto.

In the electric stove of the present invention according to claim 1, the heat rays radiated from the electric heating element are reflected by the partially elliptical mirror section of the mirror section. The heat rays reflected by the partially elliptical mirror section are reflected by the operation of the first reflective mirror section and is gathered towards the lower side of the object to be heated, so that it becomes possible to heat the object to be heated. Appropriately setting the crossing angle between the major axis of the partially elliptical mirror section and the reflective mirror section at the desired angle, the application angle of the heat rays on the lower side of the object to be heated is appropriately changeable in accordance with the size of the object to be heated. In other words, the flexibility of design of the electric stove is increased. Since the electric heating element is disposed out of the position immediately below the object to be heated, there is little possibility that contamination such as meat juice and oil adheres to the electric heating element when, for example, fish, meat, or the like is disposed on a heated place as the object to be heated. Therefore, it is possible to prevent the occurrence of smoke due to the burning of the contamination adhering to the electric heating element as much as possible.

In particular, the electric stove of the present invention according to claim 2 further includes the second reflective mirror section disposed below the object to be heated, so that the second reflective mirror section gathers the heat rays which are radiated from the electric heating element and are not reflected by the first reflective mirror section towards the lower side of the object to be heated. Thus, the heat rays radiated from the electric heating element are efficiently applied to the object to be heated without loss. In other words, the second reflective mirror section has the function of further increasing thermal efficiency.

In the electric stove of the present invention according to claim 3, in particular, the partially elliptical mirror section includes the upper section and the lower section which are separated in two in the vertical direction. Since the electric heating element is supported by the upper section of the partially elliptical mirror section, it is possible to separate the upper section of the partially elliptical mirror section supporting the electric heating element from the lower section of the partially elliptical mirror section integrally formed with the first reflective mirror section. Therefore, it also becomes possible to easily clean the lower section of the partially elliptical mirror section positioned in the vicinity of the electric heating element.

In the electric stove of the present invention according to claim 4, in particular, the anti-degradation film is formed at least on any surface of the mirror section and the first reflective mirror section on which the heat rays are applied. Thus, in heating the object to be heated such as fish and meat, even if contamination such as meat juice and oil adheres at least to any surface of the mirror section and the first reflective mirror section on which the heat rays are applied, the anti-degradation film prevents the degradation of the surfaces. Thus, reduction in the reflective efficiency of the surfaces is prevented.

In the electric stove of the present invention according to claim 5, at least any surface of the lower section of the partially elliptical mirror section, the first reflective mirror section, and the second reflective mirror section, on which the heat rays are applied, has heat resistance, and the protective member which does not prevent the reflection of the heat rays is detachably attached. Therefore, when the object to be heated such as fish and meat is heated, it is possible to prevent contamination such as meat juice and oil from adhering at least to any surface of the lower section of the partially elliptical mirror section, the first reflective mirror section, and the second reflective mirror section, on which the heat rays are applied.

### ADVANTAGES OF THE INVENTION

According to the present invention of claim 1, it is possible to obtain the electric stove which can suppress the occurrence of smoke itself as much as possible, can be miniaturized, can be easily used for cooking in ordinary households, and can increase the flexibility of design. According to the present invention of claim 2, in addition to claim 1, it is possible to obtain the electric stove which can further increase thermal efficiency. Furthermore, according to the present invention of claim 3, it is possible to obtain the electric stove which can be easily cleaned. According to the present invention of claim 4, it is possible to obtain the electric stove in which if the contamination of the object to be heated such as meat juice and oil adheres at least to any surface of the mirror section and the first reflective mirror section on which the heat rays are applied, the degradation of the surfaces are prevented. Furthermore, according to the present invention of claim 5, it is possible to obtain the electric stove which can prevent the contamination of the object to be heated such as meat juice and oil from adhering at least to any surface of the lower section of the partially elliptical mirror section, the first reflective mirror section, and the second reflective mirror section, on which the heat rays are applied.

The foregoing objects, other objects, features, and advantages of the present invention will be further apparent from the detailed description of preferred embodiments described below with reference to the drawings.

### BRIEF DESCRIPTION OF THE DRAWINGS

FIG. 1 a perspective view showing an example of an embodiment according to the present invention.

FIG. 2 a sectional view taken along the line A-A of FIG. 1.

FIG. 3 a plan view viewed from the line B-B of FIG. 2.

FIG. 4 a plan view viewed from the line C-C of FIG. 2.

FIG. 5 a partly enlarged view of FIG. 2.

FIG. 6 an explanatory view showing reflection paths of heat rays radiated from electric heating elements when objects to be heated are heated using the electric stove according to the embodiments shown in FIGS. 1 to 5.

FIG. 7 a perspective view showing another example of an embodiment according to the present invention.

FIG. 8 a plan view of the embodiment shown in FIG. 7.

FIG. 9 a plan view taken along the line D-D of FIG. 8.

FIG. 10 a plan view taken along the line E-E of FIG. 8.

FIG. 11 enlarged views showing essential parts of an example of the support structure of the electric heating element of the electric stove according to the embodiments shown in FIGS. 7 to 10, FIG. 11(A) being an enlarged view showing essential parts in a state of holding and supporting the electric heating element by a support arm, FIG. 11(B) being a plan view viewed from an arrow F of FIG. 11(A).

FIG. 12 enlarged views showing essential parts in a state of disengaging the hold and support of the electric heating element by the support arm from the state shown in FIG. 11, FIG. 12(A) being an enlarged view thereof showing the essential parts, FIG. 12(B) being a plan view viewed from arrow G of FIG. 12(A).

### DESCRIPTION OF REFERENCE NUMBERS

10 and 100 electric stove
12a and 12b mirror section
16a and 16b partially elliptical cylindrical surface
18a and 18b upper section of partially elliptical cylindrical surface
20a and 20b lower section of partially elliptical cylindrical surface
22a and 22b first reflective mirror section
24a and 24b reflection surface body
26 hold member
28 upper hold plate
30 lower hold plate
32a and 32b seethe heater
34 support member
36 pinch section
38 connection piece
40 protrusion
42 penetration hole
44 fastening means
46a, 46b, 50a, 50b, 146, and 150 flange
48a, 48b, and 148 protrusion section
52a, 52b, 152 recessed section
54 second reflective mirror section
54a and 54b reflection surface
56 catalyst film for accelerating oxidation
58 protection member
60 grill
62 object to be cooked
70 support section
72 support base
74 and 76 support bracket
78 support arm
80 rotational bracket
82 axis
116 partially elliptical rotational surface
118 upper section of partially elliptical rotational surface
120 lower section of partially elliptical rotational surface
F1a, F1b, F2a, and F2b focus

### BEST MODE FOR CARRYING OUT THE INVENTION

An electric stove, which can suppress the occurrence of smoke itself as much as possible, can be miniaturized, is easily usable in ordinary households for cooking, can further increase thermal efficiency, can increase the flexibility of design, and can be easily cleaned, is realized with a low parts count.

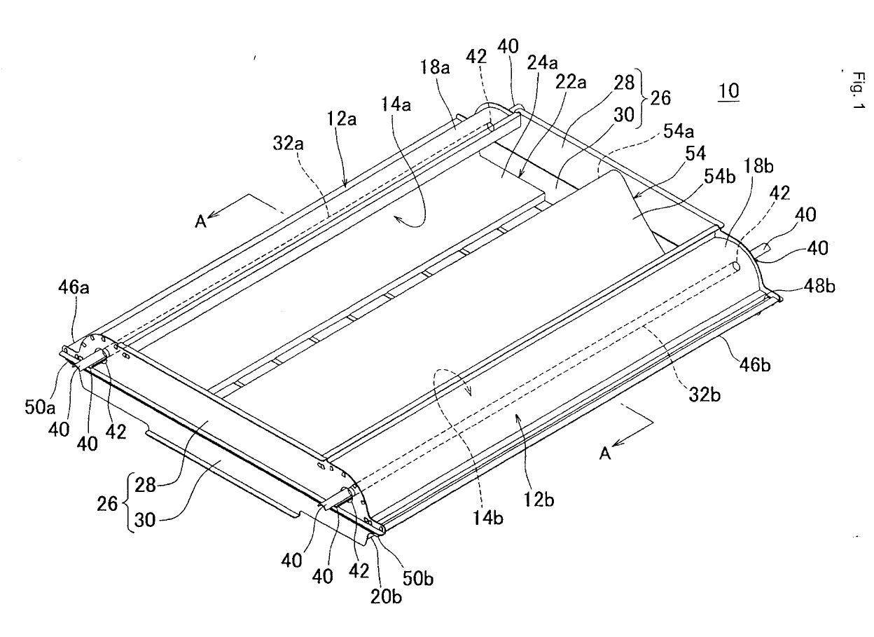

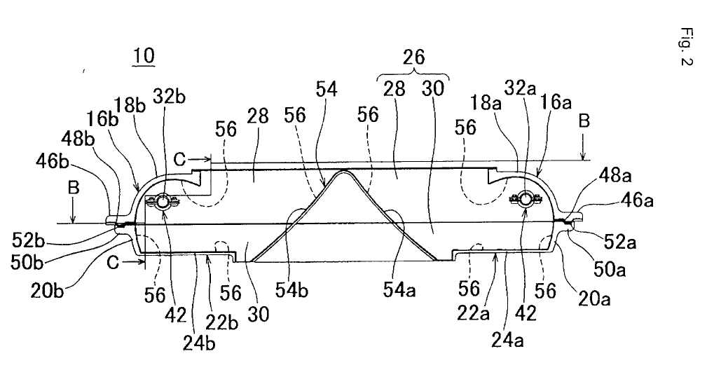

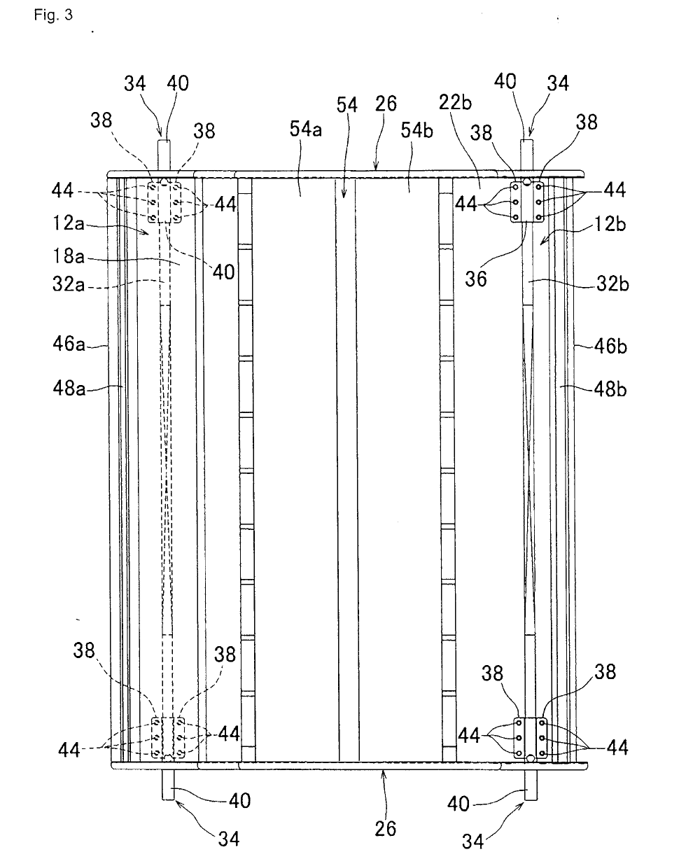

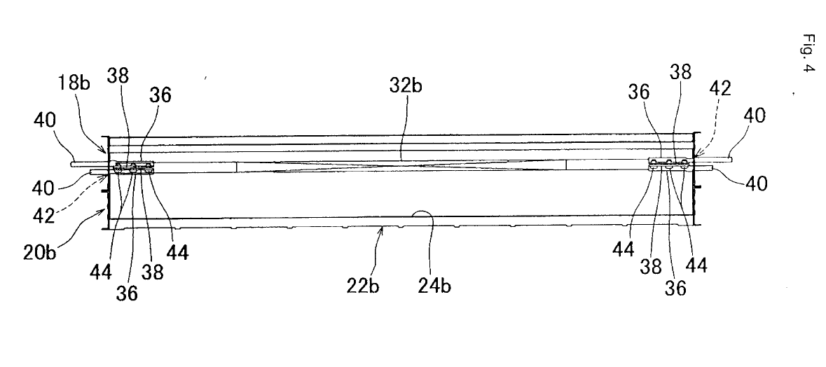

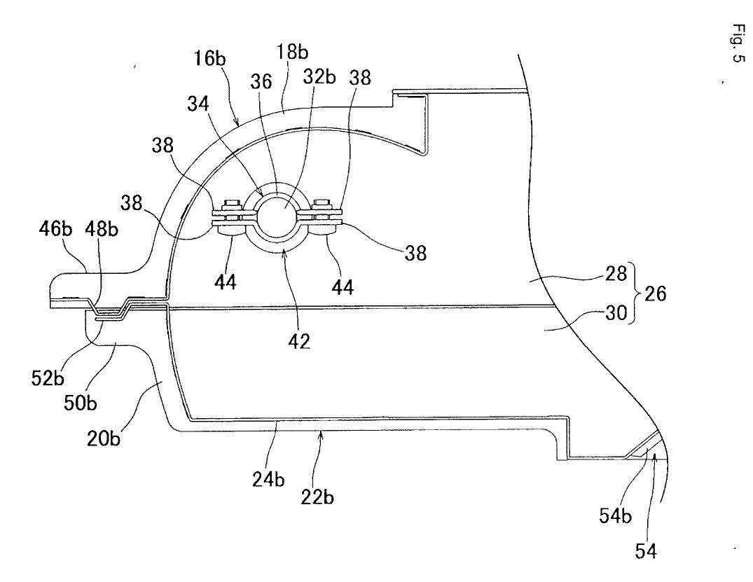

FIG. 1 is a perspective view showing an example of an embodiment according to the present invention, and FIG. 2 is a sectional view taken along the line A-A of FIG. 1. FIG. 3 is a plan view viewed from the line B-B of FIG. 2, and FIG. 4 is a plan view viewed from the line C-C of FIG. 2. FIG. 5 is an enlarged view of FIG. 2, showing essential parts.

An electric stove 10 according to the embodiment includes two mirror sections 12a and 12b. The two mirror sections 12a and 12b are formed into long plates the cross section of which is in the shape of an elliptical arc. The two mirror sections 12a and 12b, as shown in FIG. 1, are oppositely disposed in parallel at a predetermined distance away so that their opening sections 14a and 14b are opposed to each other. The two mirror sections 12a and 12b are disposed at the predetermined distance away in a direction horizontally perpendicular to the longitudinal direction of the mirror sections 12a and 12b.

Since the two mirror sections 12a and 12b have the same structure, only one mirror section 12a will be explained in detail and the detailed explanation of the other mirror section 12b will be omitted.

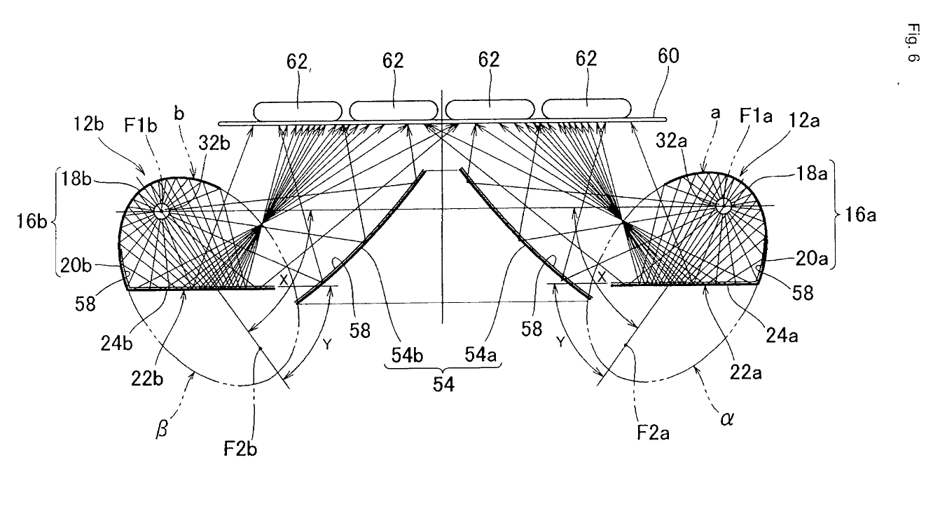

The mirror section 12a as shown in FIG. 6 includes, for example, a partially elliptical cylindrical surface 16a as a partially elliptical mirror section. The partially elliptical cylindrical surface 16a has foci F1a and F2a. The partially elliptical cylindrical surface 16a is composed of a part of an elliptical cylindrical surface. In this case, the partially elliptical cylindrical surface 16a is made of, as shown in, for example, FIG. 6, a part of a curved surface a of an elliptical cylindrical surface α.

In this case, the partially elliptical cylindrical surface 16a has an upper section 18a and a lower section 20a which can be separated in two in a vertical direction. In other words, the partially elliptical cylindrical surface 16a comprises a partially elliptical cylindrical section of the upper section 18a and a partially elliptical cylindrical section of the lower section 20a.

In the lower section 20a of the partially elliptical cylindrical surface 16a, a first reflective mirror section 22a is integrally provided. The first reflective mirror section 22a includes a reflection surface body 24a, and the reflection surface body 24a is formed into the shape of, for example, a flat plate. The first reflective mirror section 22a is disposed below seethe heaters 32a and 32b described later.

In a like manner, the other mirror section 12b includes a partially elliptical cylindrical surface 16b having an upper section 18b and a lower section 20b which can be separated in two in the vertical direction, and a first reflective mirror section 22b is integrally provided in the lower section 20b of the partially elliptical cylindrical surface 16b. The partially elliptical cylindrical surface 16b has, as shown in, for example, FIG. 6, foci F1b and F2b, and is made of part of a curved surface b of an elliptical cylindrical surface β.

Furthermore, as shown in FIGS. 1 and 3, one longitudinal end of the mirror section 12a and one longitudinal end of the mirror section 12b are connected and held by a hold member 26, and the other longitudinal ends of the mirror sections 12a and 12b are connected and held by a hold member 26. The hold member 26 includes an upper hold plate 28 and a lower hold plate 30. The upper hold plate 28 connects the upper section 18a of the first mirror section 12a to the upper section 18b of the second mirror section 12b to hold them, and the lower hold plate 30 connects the lower section 20a of the first mirror section 12a to the lower section 20b of the second mirror section 12b to hold them.

Inside the two mirror sections 12a and 12b, on the other hand, for example, the seethe heaters 32a and 32b are disposed, respectively, as electric heating elements. Inside the mirror section 12a, the seethe heater 32a is disposed in the vicinity of one focus F1a of the partially elliptical cylindrical surface 16a. Inside the mirror section 12b, the seethe heater 32b is disposed in the vicinity of one focus F1b of the partially elliptical cylindrical surface 16b. In this electric stove 10, as shown in, for example, FIG. 6, the seethe heaters 32a and 32b are disposed out of positions immediately below objects to be heated (objects to be cooked 62).

Each of both ends of the seethe heaters 32a and 32b in the longitudinal direction, as shown in, for example, FIGS. 2 to 5, is pinched and supported by two support members 34 in a vertical direction. Each support member 34 has a pinch section 36 in the shape of an arc in cross section with a predetermined length, and, as shown in, for example, FIG. 3, connection pieces 38 in the shape of a rectangle in a plan view are formed at both peripheral ends of the pinch section 36. At one end of the pinch section 36 in the longitudinal direction, as shown in, for example, FIGS. 1 and 3, a gutter-shaped protrusion 40 having the shape of an arc in cross section is formed. The pinch section 36, the connection pieces 38, and the protrusion 40 are integrally formed.

In the hold members 26, 26 of the two mirror sections 12a and 12b, on the other hand, penetration holes 42 in the shape of, for example, a round are provided oppositely to each other at both ends in its longitudinal direction. The penetration holes 42 are provided at both ends of the upper hold plate 28 in the longitudinal direction.

Each of the seethe heaters 32a and 32b is inserted between the penetration holes 42 of the opposed upper hold plates 28, 28. The pinch sections 36 of the support members 34 vertically pinch and hold each of the both longitudinal ends of the seethe heaters 32a and 32b. Furthermore, the connection pieces 38 opposed in the vertical direction are secured by fastening means 44 such as bolts and screws. In this case, the support members 34 support the seethe heaters 32a and 32b in such a manner that the protrusions 40, 40 of the support members 34 protrude to the outside of the upper hold plates 28, 28 through the penetration holes 42, 42.

Next, the structure in which each of the two mirror sections 12a and 12b can be separated in two in the vertical direction will be described with reference to, for example, FIGS. 1, 2, and 5.

Flanges 46a and 46b protruding outwards are connected to the lower face of the upper sections 18a and 18b of the partially elliptical cylindrical surfaces 16a and 16b, respectively. The flanges 46a and 46b have protrusion sections 48a and 48b in the shape of the letter U protruding downward in cross section, respectively. On the other hand, flanges 50a and 50b protruding outwards are connected to the upper face of the lower sections 20a and 20b of the partially elliptical cylindrical surfaces 16a and 16b, respectively. The flanges 50a and 50b have recessed sections 52a and 52b on which the foregoing protrusion sections 48a and 48b are mounted to be engaged, respectively. Since the protrusion sections 48a and 48b of the flanges 46a and 46b are mounted on and engaged in the recessed sections 52a and 52b on the upper face of the flanges 50a and 50b, the partially elliptical cylindrical surfaces 16a and 16b can be separated in two in the vertical direction.

In the partially elliptical cylindrical surfaces 16a and 16b, the upper section 18a and 18b and the flange 46a and 46b are integrally formed of a metal material such as stainless steel, and the lower section 20a and 20b, flange 50a and 50b, and the first reflective mirror section 22a and 22b are integrally formed of a metal material such as stainless steel which can form a mirror state on its surface. In this case, for example, a stainless plate may be folded by thin plate working and the like. Instead of the stainless plate, for example, a cupper plate or an iron plate the surface of which is subjected to mirror finish processing by metal plating or the like may be appropriately used.

As the electric heating element, a ceramic heater such as a silicon carbide heater radiating many far infrared rays may be used instead of the seethe heaters 32a and 32b. The seethe heaters 32a and 32b are used with low electric power, and the silicon carbide heater is used with high electric power. A far infrared heater is appropriately available as the electric heating element.

In the electric stove 10 according to this embodiment, as shown in, for example, FIGS. 1, 2, and 6, a second reflective mirror section 54 in the shape of a triangle in cross section is disposed between the two mirror sections 12a and 12b. The second reflective mirror section 54 includes two reflection surfaces 54a and 54b made of, for example, curved surfaces with large radius of curvature. One reflection surface 54a is disposed so as to be opposed to the opening section 14a of one mirror section 12a, and the other reflection surface 54b is disposed so as to be opposed to the opening section 14b of the other mirror section 12b. The second reflective mirror section 54 is formed by the same method as the foregoing forming method of the partially elliptical cylindrical surface 16a and 16b, the first reflective mirror sections 22a and 22b, and the like.

In this electric stove 10, for example, catalyst films 56 for accelerating oxidation are formed at least on surfaces, to which the heat rays are applied, of the first reflective mirror sections 22a and 22b of the mirror sections 12a and 12b as a film for preventing degradation. In this case, the catalyst films 56 for acceleration oxidation made of platinum, titanium oxide, or the like are formed on the inner surfaces of the upper sections 18a and 18b and the lower sections 20a and 20b of the partially elliptical cylindrical surfaces 16a and 16b, the inner surfaces of the first reflective mirror sections 22a and 22b, and the reflection surfaces 54a and 54b of the second reflective mirror section 54.

Furthermore, in this electric stove 10, as shown in, for example, FIG. 6, of the lower sections 20a and 20b of the partially elliptical cylindrical surfaces 16a and 16b, the first reflective mirror sections 22a and 22b, and the reflection surfaces 54a and 54b of the second reflective mirror section 54, at least the surfaces on which the heat rays are applied are covered with a heatproof protection member 58 which does not prevent the reflection of the heat rays. In this case, for example, an aluminum foil, which is easily changeable and is made of a material with high reflectivity of the heat rays, is used as the protection member 58. As the protection members 58 for covering the lower sections 20a and 20b and the first reflective mirror sections 22a and 22b of the partially elliptical cylindrical surfaces 16a and 16b, there are members in which an aluminum foil is integrally formed on the surface of a heatproof base material. As the protection member 58, for example, a sheet-type heat-resistant glass which has the high penetration of the heat rays and is superior in heat resistance may be appropriately used.

In this electric stove 10, as shown in, for example, FIG. 6, in the one mirror section 12a and the other mirror section 12b opposed thereto, an angle X which a line connecting the center of the seethe heater 32a to the center of the seethe heater 32b forms with the major axis of the one partially elliptical cylindrical surface 16a is appropriately set in a range of 0 to 90 degrees.

Furthermore, an angle Y which the major axis of the partially elliptical cylindrical surface 16a forms with the first reflective mirror section 22a is appropriately set in a range of, for example, 20 to 70 degrees. When the first reflective mirror section 22a is a curved surface, an angle which a part of the curved surface forms with the major axis of the partially elliptical cylindrical surface 16a is appropriately set in a range of, for example, 20 to 70 degrees.

In this electric stove 10, particularly shown in FIGS. 1, 2, and 6, the two mirror sections 12a and 12b and the first reflective mirror sections 22a and 22b are symmetrically disposed with respective to the center line of the second reflective mirror section 54.

In the electric stove 10 shown in FIGS. 1 to 6, a grill 60 such as, for example, wire netting and wire grid is mounted between upper ends of the two mirror sections 12a and 12b (refer to FIG. 6). On the grill 60, objects to be cooked 62 such as, for example, meat and fish are mounted as the objects to be heated.

In this electric stove 10, since the seethe heaters 32a and 32b are disposed sufficiently away from positions immediately below the objects to be cooked 62, contamination such as meat juice and oil from the objects to be cooked 62 hardly adheres, so that the occurrence of smoke can be suppressed as much as possible. Accordingly, the electric stove 10 does not need a smoke collection unit because the occurrence of smoke itself coming out in grilling fish and meat is suppressed as much as possible, and hence the electric stove 10 is easily usable also in ordinary households. Thus, it becomes possible to grill meat and fish without the occurrence of smoke. In this case, food can be cooked in a place without a ventilator like a dining room in contrast to before. When, for example, the silicon carbide heater is used as the electric heating element, the heat rays include many far infrared rays, so that cooked food is heated to the inside and it becomes possible to properly brown its surface with keeping moisture inside.

In this electric stove 10, the heat rays radiated from the seethe heaters 32a and 32b are reflected by the partially elliptical cylindrical surfaces 16a and 16b. The heat rays reflected by the partially elliptical cylindrical surfaces 16a and 16b are reflected by the first reflective mirror sections 22a and 22b and are gathered towards the lower side of the grill 60, so that it is possible to heat the objects to be cooked 62. Appropriately setting the crossing angle (Y of FIG. 6) between the major axis of the partially elliptical cylindrical surface 16a and 16b and the first reflective mirror section 22a and 22b to a desired angle, it is possible to appropriately vary an angle of applying the heat rays on the lower side of the grill 60 in accordance with the size of the objects to be cooked 62, in other words, in accordance with the size of the grill 60.

In other words, speaking in the case of, for example, FIG. 1, since it is possible to appropriately set the distance between the opposed two partially elliptical cylindrical surfaces 16a and 16b in the direction of width, the distance between the grill 60 and the first reflective mirror sections 22a and 22b in the direction of height, or the like in this electric stove 10, the flexibility of design is increased.

In particular, this electric stove 10 has the reflection surfaces 54a and 54b of the second reflective mirror section 54 disposed below the objects to be cooked 62, so that the reflection surfaces 54a and 54b of the second reflective mirror section 54 gather the heat rays which are radiated from the seethe heaters 32a and 32b and are not reflected by the reflection surface bodies 24a and 24b of the first reflective mirror sections 22a and 22b towards the lower side of the objects to be cooked 62. Therefore, the heat rays radiated from the seethe heaters 32a and 32b are efficiently applied on the grill 60 on which the objects to be cooked 62 are mounted without loss. In other words, the reflection surfaces 54a and 54b of the second reflective mirror section 54 have the function of further increasing thermal efficiency.

Furthermore, particularly in this electric stove 10, the upper sections 18a and 18b are mounted on and engaged in the lower sections 20a and 20b so that each of the two partially elliptical cylindrical surfaces 16a and 16b can be separated in two in the vertical direction, and the seethe heaters 32a and 32b are inserted into and supported by the penetration holes 42 of the upper sections 18a and 18b of the partially elliptical cylindrical surfaces 16a and 16b. Therefore, it is possible to separate the upper sections 18a and 18b of the partially elliptical cylindrical surfaces 16a and 16b for supporting the seethe heaters 32a and 32b from the lower sections 20a and 20b of the partially elliptical cylindrical surfaces 16a and 16b which are integrally formed with first reflective mirror sections 22a and 22b.

In other words, it is possible to easily detach the upper sections 18a and 18b of the partially elliptical cylindrical surfaces 16a and 16b together with the seethe heaters 32a and 32b from the lower sections 20a and 20b of the partially elliptical cylindrical surface 16a and 16b which are integrally formed with the first reflective mirrors 22a and 22b, and it is also easy to replace them.

Therefore, in this electric stove 10, it is possible to extremely easily clean even the lower sections 20a and 20b of the partially elliptical cylindrical surfaces 16a and 16b positioned in the vicinity of the seethe heaters 32a and 32b.

In this electric stove 10, even if the contamination such as meat juice and oil coming out of the heated cooked objects 62 adheres to the inner surfaces of the upper sections 18a and 18b and the lower sections 20a and 20b of the partially elliptical cylindrical surfaces 16a and 16b, the inner surfaces of the first reflective mirror sections 22a and 22b, the surface of the reflection surfaces 54a and 54b of the second reflective mirror section 54, and the like, for example, the catalyst film 56 for accelerating oxidation being a film for preventing degradation oxidizes the contamination. Accordingly, the degradation of these surfaces is prevented and hence it is possible to prevent reduction in the reflection efficiency of these surfaces.

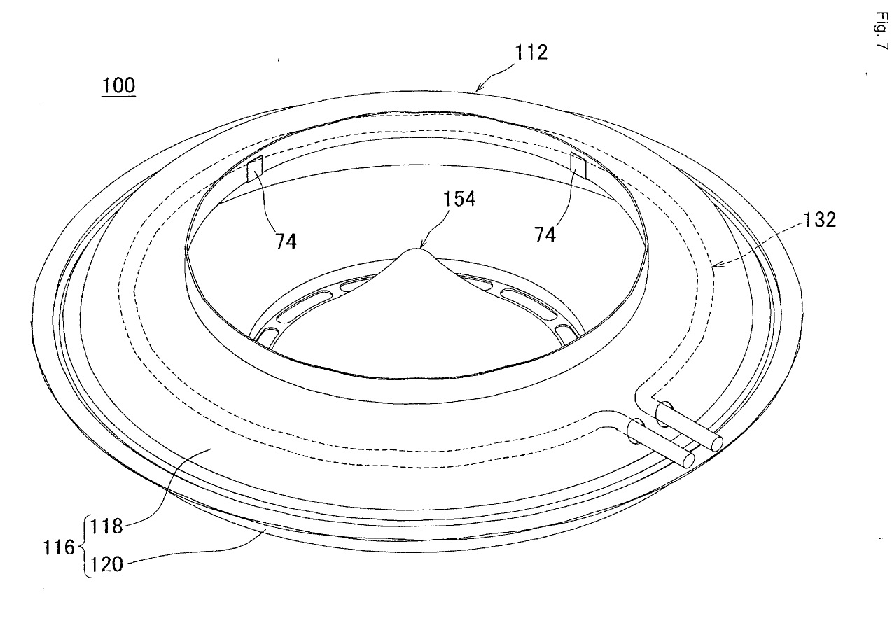

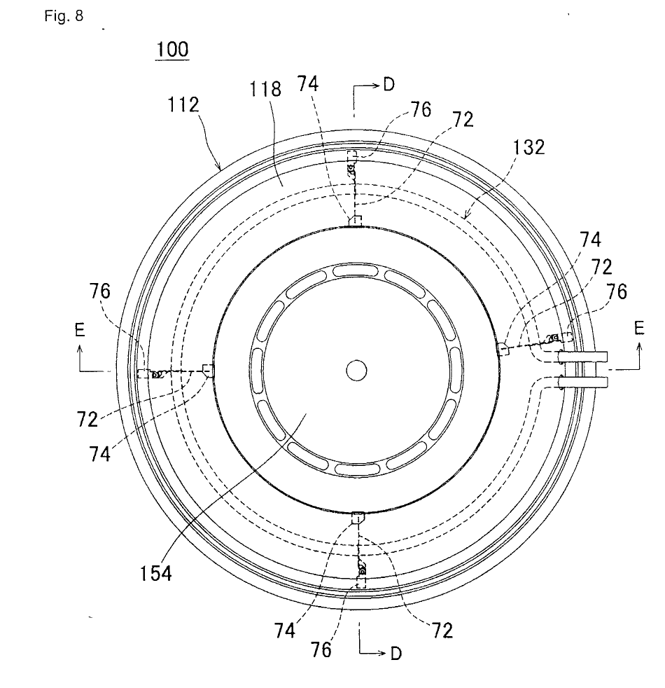

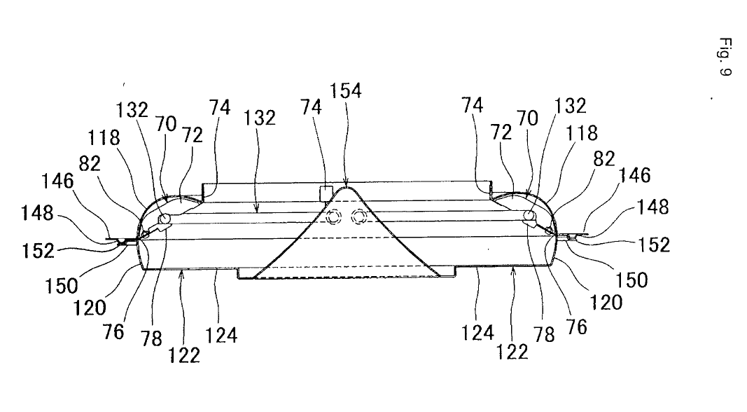

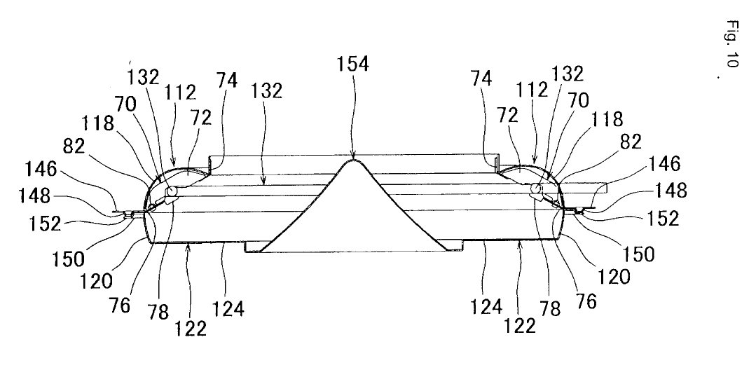

FIG. 7 is a perspective view showing another example of an embodiment according to the present invention, and FIG. 8 is a plan view of the embodiment shown in FIG. 7. FIG. 9 is a plan view taken along the line D-D of FIG. 8, and FIG. 10 is a plan view taken along the line E-E of FIG. 8. In an electric stove 100 according this embodiment, the structure of partially elliptical cylindrical surfaces composing mirror sections, the structure of electric heating elements, the structure of first reflective mirror sections, and the structure of a second reflective mirror section are especially different from those of the electric stove 10 according to the foregoing embodiment.

In other words, the mirror sections 12a and 12b, as shown in, for example, FIG. 1, are composed of the partially elliptical cylindrical surfaces 16a and 16b as partially elliptical mirror sections in the electric stove 10 according to the foregoing embodiment. In the electric stove 100 shown in FIGS. 7 to 10, however, the partially elliptical mirror section composing a mirror section 112 comprises a single partially elliptical rotational surface 116. The electric heating element comprises, for example, a single seethe heater 132 in the shape of a ring. Furthermore, a reflection surface body 124 of a first reflective mirror section 122 is formed into the shape of, for example, a disk. Furthermore, a second reflective mirror section 154 is formed into the shape of, for example, a cone.

In this electric stove 100, as with the electric stove 10, the partially elliptical rotational surface 116 has an upper section 118 and a lower section 120 which can be separated in two in a vertical direction, and a partially elliptical rotational surface of the upper section 118 and a partially elliptical rotational surface of the lower section 120 compose the partially elliptical rotational surface 116. In this case, since protrusion sections 148 of a flange 146 are mounted on and engaged in recessed sections 152 in an upper surface of a flange 150, the upper section 118 and the lower section 120 of the partially elliptical rotational surface 116 can be separated in two in the vertical direction.

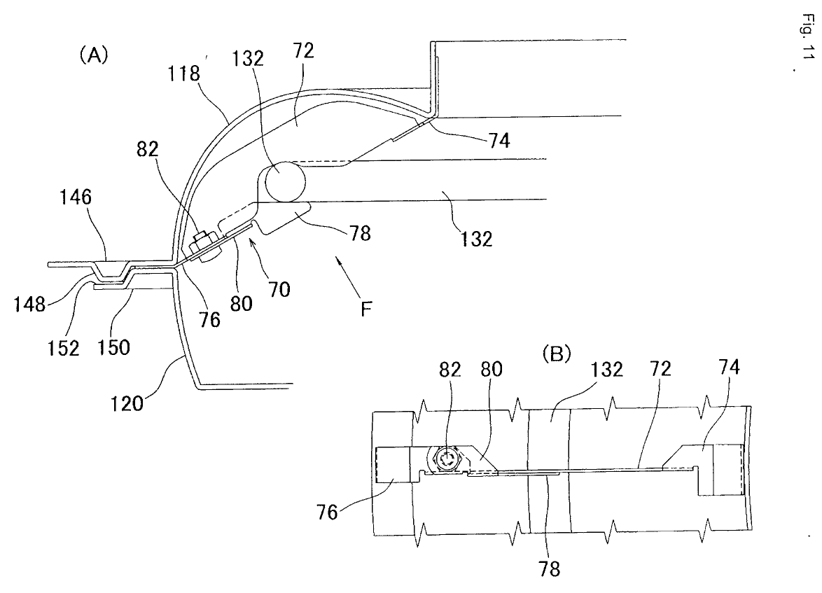

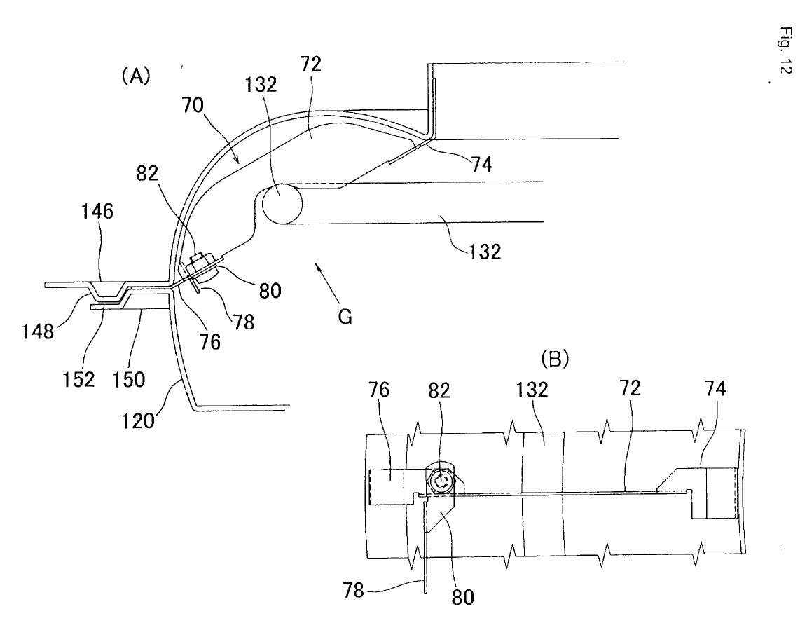

In this electric stove 100, as shown in, for example, FIGS. 8 to 10, the ring-shaped seethe heater 132 is supported by, for example, four support sections 70. The four support sections 70 are disposed at approximately regular intervals in the peripheral direction of the seethe heater 132. The four support sections 70 have the same structure, so one of the support sections 70 will specifically be described with reference to, for example, FIGS. 11 and 12.

Namely, the support section 70 has a support base 72 in the shape of, for example, the letter of flat C. The support base 72 is disposed so as to make contact with an upper side of the seethe heater 132. One end and the other end of the support base 72 in a longitudinal direction are attached to an upper end and a lower end of the upper section 118 of the partially elliptical rotational surface 116 by support brackets 74 and 76, respectively. A support arm 78 is rotatably provided at an end of one support bracket 76. The support arm 78 is secured to an end of a rotational bracket 80. The support bracket 76 rotatably supports the rotational bracket 80 through axial section 82 such as a bolt and a pin. Therefore, the support arm 78 is rotatable in synchronization with the rotation of the rotational bracket 80.

When objects to be heated (objects to be cooked 62) are heated using this electric stove 100, the reflection paths of heat rays radiated from the electric heating element (seethe heater 132) are approximately the same as those in the case of the electric stove 10 explained with reference to, for example, FIG. 6. Furthermore, this electric stove 100 has the same functions and effects as the electric stove 10 described above.

### INDUSTRIAL APPLICABILITY

The electric stove according to the present invention heats objects to be heated by radiant heat, and is suitably used for cooking foodstuff such as, for example, fish and meat.

1: An electric stove comprising:
an electric heating element disposed out of a position immediately below an object to be heated;
a mirror section for reflecting heat rays radiated from the electric heating element; and
a first reflective mirror section disposed below the electric heating element to gather the heat rays reflected by the mirror section towards the lower side of the object to be heated, wherein
the mirror section includes a partially elliptical mirror section which has one focus in the vicinity of the electric heating element to reflect the heat rays radiated from the electric heating element, and
the partially elliptical mirror section is connected to the first reflective mirror section so that the major axis connecting the one focus of the partially elliptical mirror section to the other focus of the partially elliptical mirror section appropriately crosses the reflective mirror section at a desired angle.

2. The electric stove according to claim 1, further comprising a second reflective mirror section disposed below the object to be heated to gather heat rays, which are radiated from the electric heating element and are not reflected by the first reflective mirror section, towards the lower side of the object to be heated.

3. The electric stove according to claim 1, wherein:
the partially elliptical mirror section includes an upper section and a lower section which can be separated in two in a vertical direction; and
the electric heating element is supported by the upper section of the partially elliptical mirror section, and the lower section of the partially elliptical mirror section is integrally formed with the first reflective mirror section.

4. The electric stove according to any of claim 1, further comprising an anti-degradation film formed at least on a surface of the mirror section and the first reflective mirror section on which the heat rays are applied.

5. The electric stove according to any of claim 1, wherein at least a surface of the lower section of the partially elliptical mirror section, the first reflective mirror section, and the second reflective mirror section, on which the heat rays are applied, has heat resistance, and a protection member which does not prevent the reflection of the heat rays is detachably attached thereto.
